(19) United States
(12) Patent Application Publication
(10) Pub. No.: US 2010/0268961 A1
(43) Pub. Date: Oct. 21, 2010

(54) Method and Arrangement for User Validation

(75) Inventors: Steven M. Cole, New South Wales (AU); Michael Wilmot, New South Wales (AU); Michael J. Hammond, New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(73) Assignee: VALID8 TECHNOLOGIES PTY LTD., Bella Vista New South Wales (AU)

(21) Appl. No.: 12/669,358

(22) PCT Filed: Jul. 4, 2008
(86) PCT No.: PCT/AU2008/000985

§ 371 Date: Jul. 6, 2010

(30) Foreign Application Priority Data
Jul. 17, 2007 (AU) 2007903839
Aug. 9, 2007 (AU) 2007904288

(51) Int. Cl. G06F 21/20; G06F 21/22; H04L 9/32

(52) U.S. Cl. 713/186; 726/2; 726/9; 726/7

(57) ABSTRACT

A controlled access storage device includes a resource store storing two or more resources, the resource store having two or more levels of administration, wherein at least a first administration level is adapted to provide exclusive access to at least a first resource. The system includes an access control server (102) or validation terminal, an educational course server or resource server (104) including a resource database, a registration terminal (106) and fingerprint reader (110), and one or more user terminals (116) with associated user terminals fingerprint reader (118), and one or more registration terminals. The fingerprint readers has a “swipe pad” (112) with a line scanner (114) adapted to record characteristics of the fingerprint as it is swiped across the reader across. The various terminals and servers are interconnected via a communication network (120), such as the internet.

### FIELD OF THE INVENTION

This invention relates to a method and arrangement for on-line or stand alone USB apparatus user validation.

The invention is applicable to systems which make information or participation available under conditions which require a degree of security. the invention will be described in the context of on-line student identification in so called e-learning and web based training environments. It is also applicable to the standalone USB version of the apparatus which fully houses all required components on the USB apparatus.

### BACKGROUND OF THE INVENTION

Current USB Flash drives usually provide only a single level of administration and one level of user access, effectively a two-tier administration structure in which the administration level can usually access all content and functions, while the user can access a limited portion of the content and functions. The administrator has exclusive access and/or control of specific administration content and functions.

The stand alone FPV (fingerprint verification) USB apparatus can provide “anywhere, anytime” instruction that is delivered by a stand alone fully self contained USB apparatus or over the Internet to any browser-equipped computer. This stand alone USB apparatus helps to meet the needs of but is not limited to corporate environments, HR managers, educational facilities, workers, and life-long learners because it is available on demand, requires no travel, and is more cost-effective than classroom based training. With proper instructional design, E-learning can actually be more interactive than traditional classroom training, providing more personal and timely feedback to meet learners' needs. Such systems may include the compulsory completion of course material and may also include assessment. However there is a problem in confirming the identity of the remote student, and this leaves the system vulnerable to fraud, in that a person other than the registered student may in fact log in to the course server and complete the required course material.

The current system being used by E-learners in Universities, TAFEs, RTOs, Private & Public Colleges and Corporate facilities involves a standard user name and password, or multiple user names and passwords, and once issued systems can be accessed by just about anyone. With the current system anyone can enter the username and password and then access the information package, complete a training course, or online HR training or whatever the username and password is being used to validate, and be awarded a qualification. This does not prevent, for example, a first person who has as medical degree from completing a Certificate in Senior First-Aid for a second person.

### SUMMARY OF THE INVENTION

The invention provides a device, method and arrangement of controlling access to a resource.

The device can be adapted to provide a number of levels of administration and access.

The device can implement biometric identification.

The device can include a biometric characteristic reader, and can be adapted to store user identification information including user biometric information.

The device can adapted to access on-line resources.

The device can be adapted to store resources within the device.

Access can be controlled by the use of a biometric identifier.

Continued access can be periodically verified by the use of biometric revalidation.

User biometric information can be stored in a plug-in device adapted to be connected to a terminal.

The plug-in device can have two or more levels of authorized access.

The plug-in device can have three levels of authorized access.

The plug-in device can store one or more controlled resources.

The plug-in device can include a user validation function.

The plug-in device can include a user revalidation function.

The plug-in device can include an on-line user registration function.

The plug-in device can include a recourse monitoring function.

The plug-in device can include a reporting system to send reports to a resource supervision site.

The reports can include user progress reports.

The reports can include invalid access attempt reports.

The reports can be sent via email.

According to one aspect of the invention there is provided a validation arrangement and method for accessing a resource which provides continuing verification of the presence of an authorized user during an attempt to access information stored on-line with the course material stored at a remote server, or in a stand alone mode with the course material stored in a local device or USB apparatus or on a local terminal.

According to an embodiment of the invention, there is provided a method of verifying the presence of an authorized user during an attempt to access information stored in a first on-line information store, the method including the steps of: recording and storing at least one biometric characteristic of an authorized person on the stand alone USB FPV device or in an authorization database together with associated used identity information;

receiving a log-in request from a user;
requesting the user to provide specified biometric information;
receiving specified biometric information from the user;
comparing the biometric information with the biometric characteristic;
if the biometric information matches the biometric characteristic, granting access to the on-line information.
if the biometric information does not matches the biometric characteristic, granting access to the on-line information.

If the biometric information does not match the biometric characteristic, access to the on-line information is inhibited.

The log-in request can include user identification information.

If the user request does not contain user identification information, user identification information is requested from the user on receipt of the log-in request.

When a user has been granted access, one or more subsequent requests for user biometric information can be made.

A token can be provided to the user terminal when the user terminal has been validated, and the user terminal can transmit the token to the resource terminal to gain access to the designated resource information.

According to an embodiment of the invention, there is provided an access controller adapted to mediate access between one or more user terminals and a resource terminal, the access controller including:

a memory adapted to store user registration information including user identification information and associated user specific registration biometric information;
biometric information analysis means adapted to compare registered user specific registration biometric information with request biometric information associated with an access request from a user terminal;
the controller being adapted to authorize/enable or deny/inhibit the user terminal to access at least a designated part of the resource on the basis of the comparison.

The user registration information can include associated user access information.

The access controller can be adapted to receive user specific registration biometric information from registration means.

The registration means can include a biometric scanner.

The registration means can include digitizing means to convert the scanned biometric characteristic to digital format.

The invention also provides a user authorization system for accessing a resource, including:

a user register including user biometric information associated with user identification information and user access authorization;
a resource terminal including one or more limited access packages;
one or more user terminals;
validation means associated with the user register;
each user terminal having a corresponding first biometric sensor connected to the user terminal;
wherein:
the first biometric sensor is adapted to produce and communicate user specific biometric information to the user register via a stand alone USB apparatus or a first communication network;
the validation means is adapted analyse the user specific biometric information to determine corresponding user access authorization, and to notify the stand alone USB apparatus or a resource terminal of the user access authorization;
the stand alone USB apparatus or the resource terminal being adapted to grant or deny access to one or more designated packages on the basis of user authorization notification from the validation and re-validation means; and
wherein the user terminal or the stand alone USB apparatus is connectable to the or each designated package via stand alone USB apparatus or a communication network.

The stand alone USB device or apparatus can report back to a server contemporaneously or when the next available server connection is available.

A second biometric sensor can be associated with the user register to record the user biometric information.

The system can include one or more user registration terminals adapted for recording user identification information, user access information, each user registration terminal having one or more biometric sensors adapted for producing user specific biometric information and transmitting the user specific biometric information and user identification information to the user register.

The user terminals can be connected to the user register via the stand alone USB apparatus or a first communication network.

The user register terminals can be connected to the user register via the stand alone USB apparatus or a second communication network.

The user register can be incorporated in the stand alone USB apparatus or resource terminal.

The user register can be connected to the resource terminal via the stand alone USB apparatus or the first communication network.

The user register can be connected to the stand alone USB apparatus or the resource terminal via a third communication network.

The registration terminals can be connected to the user register via the stand alone USB apparatus or the first communication network.

The registration terminals can be connected to the user register via the stand alone USB apparatus or a fourth communication network.

The registration terminals can be connected to the resource terminal via the stand alone USB apparatus or a first communication network.

The registration terminals can be connected to the resource terminal via the stand alone USB apparatus or a fifth communication network.

The registration terminals can be incorporated into the resource terminal.

The registration terminal can be a stand alone USB apparatus.

The packages can include information.

The packages can include software.

Biometric characteristics can be selected from fingerprint, iris, retina, voice, DNA, facial, ear, hand, odour, and other characteristics having a sufficient degree of uniqueness.

The user identification information and the user access information to the resource or the stand alone USB apparatus

In one embodiment, the invention utilizes fingerprint verification means and random re-validation to prevent unauthorized access of the data-training courses, text files, images, assessments or whatever has been added to the apparatus.

The apparatus can be adapted to continually verify that the user accessing the information package is authorized to do so, and confirm that the user is the person who initially gained access to the server or to the stand alone USB apparatus.

The apparatus can be adapted to send encrypted data reports to a nominated server, email client or LMS (Learning Management System), at the initial validation, re-validations, commencement & completion phases of learning, commencement and completion phases of assessment and includes assessment results in encrypted format or non encrypted format as set by the admin level user or at access to the specified information packages or may store the encrypted data on the stand alone USB apparatus and then sent and the next available connection to the internet; to a nominated server, email client or LMS, the initial validation, re-validations, commencement & completion phases of learning, commencement and completion phases of assessment and includes assessment results in encrypted format or non encrypted format as set by the admin level user

### BRIEF DESCRIPTION OF THE DRAWINGS

An embodiment or embodiments of the present invention will now be described, by way of example only, with reference to the accompanying drawings.

FIG. 1 illustrates a computer network according to an embodiment on which the invention can be implemented;

FIG. 2 shows a schematic functional block representation of a computer. suitable for use in implementing the invention;

FIG. 3 shows a flow diagram of a log-in process according to an embodiment of the invention;

FIG. 4 shows a functional block diagram of a user terminal according to an embodiment of the invention;

FIG. 5 shows a functional block diagram of a registration terminal according to an embodiment of the invention;

FIG. 6 shows a functional block diagram of an access controller according to an embodiment of the invention;

FIG. 7 shows a functional block diagram of a resource server according to an embodiment of the invention;

FIG. 8 shows a flow chart of a registration process according to an embodiment of the invention;

FIG. 9 shows a flow chart of a log-in process according to an embodiment of the invention;

FIG. 10 shows a flow chart of a random check process according to an embodiment of the invention;

FIG. 11 shows a flow chart illustrating an alternative log-in process according to an embodiment of the invention;

FIG. 12 shows a block diagram illustrating the administration levels of the system updating of a user in an arrangement embodying the invention;

FIG. 13 is a block diagram illustrating an enrolment process according to an embodiment of the invention;

FIG. 14 shows a block diagram illustrating a log in process according to an embodiment of the login process.

FIG. 15 illustrates login interactions.

FIG. 16 illustrates a message encapsulation. process according to an embodiment of the invention;

FIG. 16 illustrates the message encapsulation process at the user level;

FIG. 17 illustrates fingerprint reader administration. The multi-level access for the memory stick dongle according to an embodiment of the invention;

FIG. 18 schematically illustrates an initial log in process.

FIG. 19 illustrates a routine log in process;

FIG. 20 illustrates a dual validation log in process.

FIG. 21 is a block schematic illustration of a USB device connected to a computer.

FIG. 22 is a schematic block diagram of the superadministration level arrangement adapted for use in a plug-in device.

FIG. 23 is a schematic block diagram of the administration level arrangement adapted for use in a plug-in device.

FIG. 24 is a schematic block diagram of the user administration level arrangement adapted for use in a plug-in device.

FIG. 25 is a schematic block diagram illustrating functionality of a plug-in device programmed according to an embodiment of the invention.

FIG. 26 is a flow diagram illustrating operation of the device of FIG. 25.

### DETAILED DESCRIPTION OF THE EMBODIMENT OR EMBODIMENTS

The invention will be described with reference to the embodiments shown in the accompanying drawings.

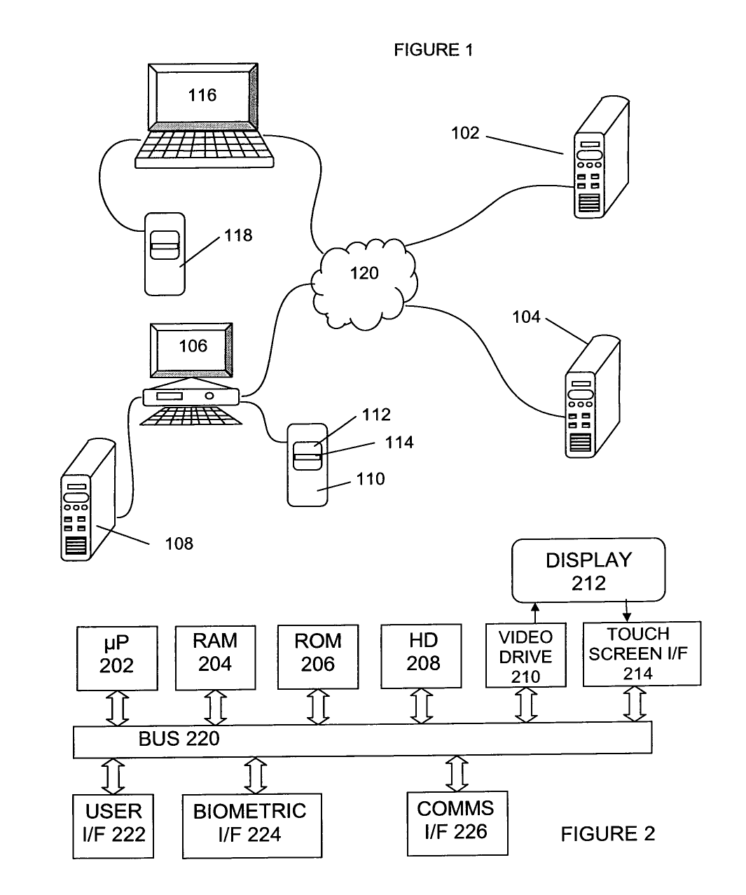

FIG. 1 illustrates a network adapted for the implementation of an embodiment of the invention. FIG. 1 shows an access control server 102 or validation terminal, an educational course server or resource server 104 including a resource database, a registration terminal 106 and fingerprint reader 110, and a user terminal 116 with associated user terminals fingerprint reader 118. There may be a plurality of user terminals such as 116, and one or more registration terminals. The fingerprint readers can include a “swipe pad” 112 across which a user can swipe a finger, there being a line scanner 114 adapted to record characteristics of the fingerprint as it is swiped across the reader. The various terminals and servers are interconnected via a communication network 120, such as the internet. However, the communication network can be an intranet, LAN, WAN or other suitable communication network. The registration terminal can be an independent terminal or it can be associated with the resource terminal or the validation terminal.

In an alternative embodiment, the registration function of server 106, the access control function of server 102 and the education course information of server 104 may all be implemented on a single machine. In a further embodiment, the functions may be implemented on two machines.

The education server 104 can contain one or more separately accessible portions, corresponding, for example, to specific courses or course segments for which users 116 may be registered and thus authorized to access.

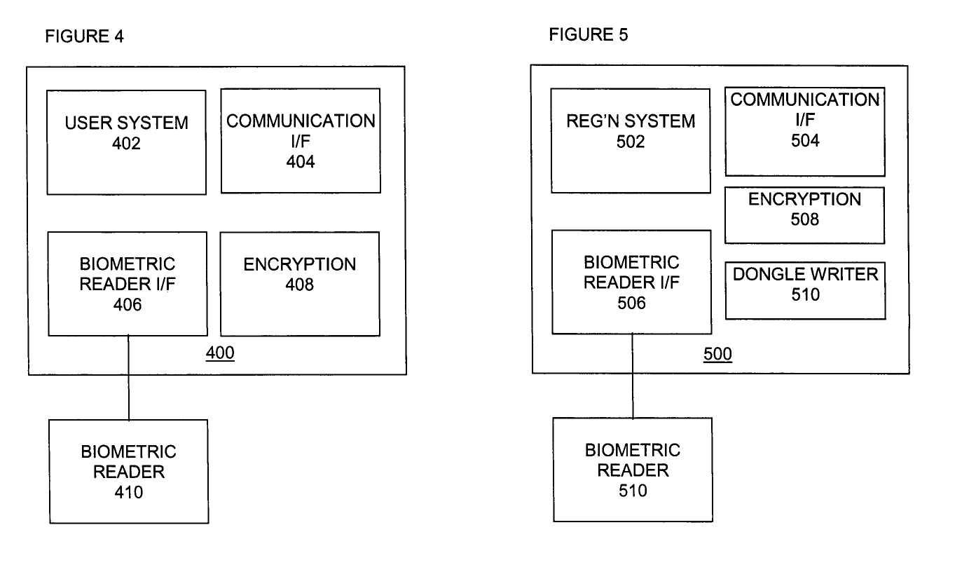

FIG. 4 shows a functional block diagram illustrating relevant functions of the user terminal 400. The user terminal includes a user system which adapted to work with the access controller and resource server. A biometric characteristic, such as a fingerprint scanner 410 is connected to the user terminal 400 via a biometric reader interface 406. The user terminal 400 can also include an encryption function 408 to provide security for the user identification and biometric information. A communication interface 404 enables the user terminal to communicate over a communication network.

FIG. 5 shows a functional block diagram illustrating relevant functions of the registration terminal 500. The registration terminal 500 has an associated biometric reader 510, again a fingerprint scanner in this embodiment. The registration terminal includes a biometric reader interface 506 and encryption function 508, as well as the registration system program function 502 and communication interface 504 to manage the processing and transfer of the user identification and biometric information to the access control function.

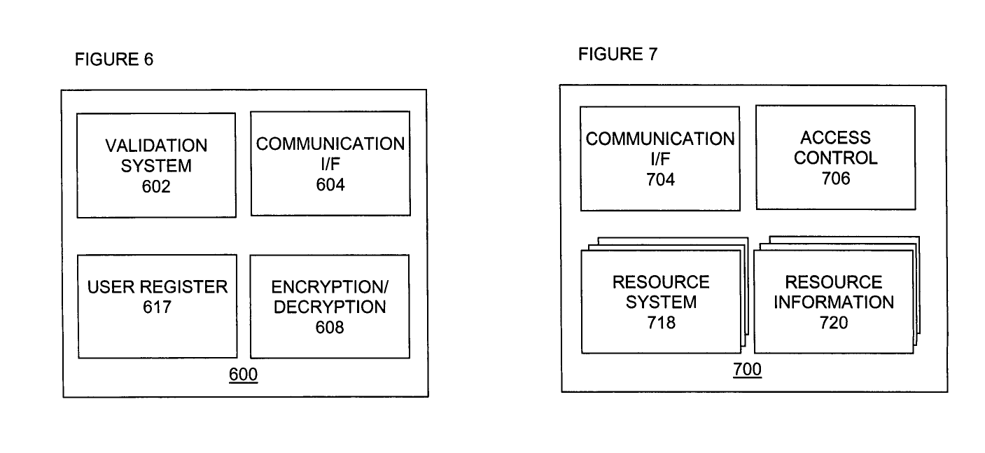

FIG. 6 shows a functional block diagram illustrating relevant functions of the access controller 600. The access controller 600 includes a user register 617 which stores user identification and associated biometric information from the registration process. The register 617 may also include the access rights of the user, limiting the access of the user to specified portions of the resource information. Alternatively, the access rights may be contained at the resource server. The access controller also has appropriate encryption/decryption functionality 608. A validation system 602 and communication interface 604 enable the access controller to receive user access requests and associated user identification and biometric information for comparison with the corresponding registered information, and to grant or deny access depending on the validation analysis. The granting or refusal of access is communicated to the resource server. The validation system 602 also implements random validation actions during a user session with the resource server.

FIG. 7 shows a functional block diagram illustrating relevant functions of the resource server 700. The resource server 700 includes a resource system 718 and resource information which can be partitioned into separate packages, and the user access can be limited to specified packages. A communication interface 704 enables the resource server to communicate with the user and the access controller. In practice, this can be done over one network using a single communication protocol, or there can be different networks and protocols for the access controller and the user. An access control function interacts with the access controller to grant or deny access. As mentioned above, the access controller's user register 617 may also include the user's access rights, and this information is then sent to the resource server's access control function 706, so the user can be granted the appropriate access. Alternatively, where the resource server includes information relating to a user's access rights, once the user has been authenticated by the access controller 600, the resource server can grant the specified access.

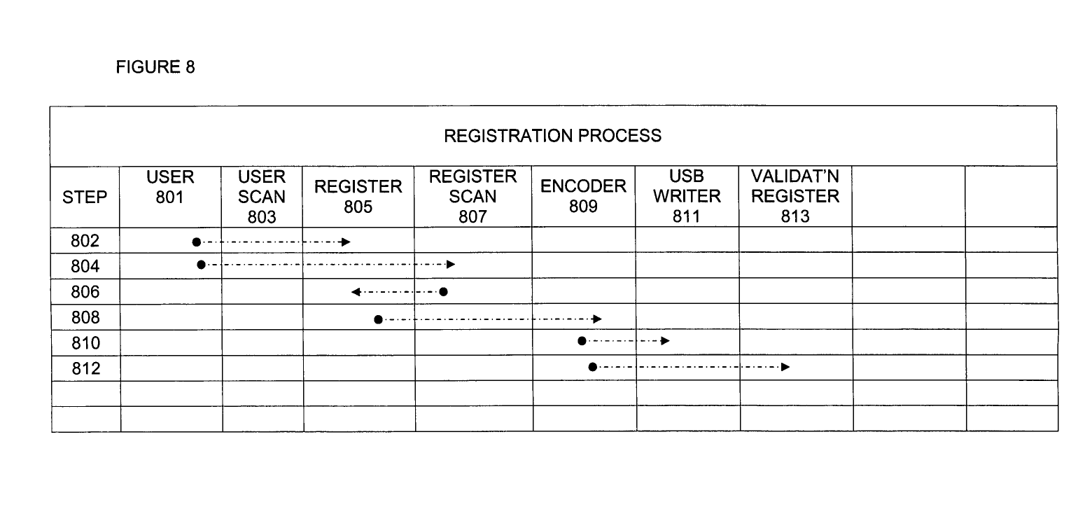

FIG. 8 shows a flow chart of a registration process according to an embodiment of the invention. The flow chart shows the various entities involved in the registration process, including:

the user 801;
the user scanner 803;
access control 805;
access validation 807;
registration agency 809;
registration scanner 811;
resource access 813;
resource 815.

In order to register, the user 801 must physically attend a registration agency 809 which has the appropriate fingerprint or other biometric reader 811. Having a number of registration agencies in various geographical locations makes the registration process more convenient than requiring the user to physically attend the educational or other institution which provides the resource 815.

When the user 801 attends the registration agency 809, the user must first establish his or her identity, for example by the use of a points system for official documentation and the like such as passport, driver's licence, birth certificate, etc. In addition, details of the access to be provided to the user may also be recorded at the registration agency for transmission to the controller. Further, user ID and password may also be recorded at this stage. This information may already have been provided to the user or the registration agency by the university or institution providing the resource. At step 802, the user's identification information is then recorder at the registration agency, and, at step 804, the user's fingerprint is read using the fingerprint scanner at the registration agency. The fingerprint information is associated with the user identification information at step 806, and, at step 808, transmitted to the access controller 805 for recordal.

The controller 805 then notifies the resource access of the registration of the user at step 810.

The registration agency provides the user with a fingerprint scanner 803 at steps 812, 814. This scanner 803 can include unique device identification information. This device identification information may be recorded with the user information at the controller 805 during step 808.

In an optional step (not shown), the access controller 805 can send an acknowledgement message to the registration agency 809 indicating successful recordal of the user's details, and the registration agency can then delete all or part of the user information from its records. In particular, the user biometric data may be deleted for security reasons. In the event of an unsuccessful attempt to record the information at the controller, the controller can send a request for retransmission, or re-recording and retransmission, of the user information.

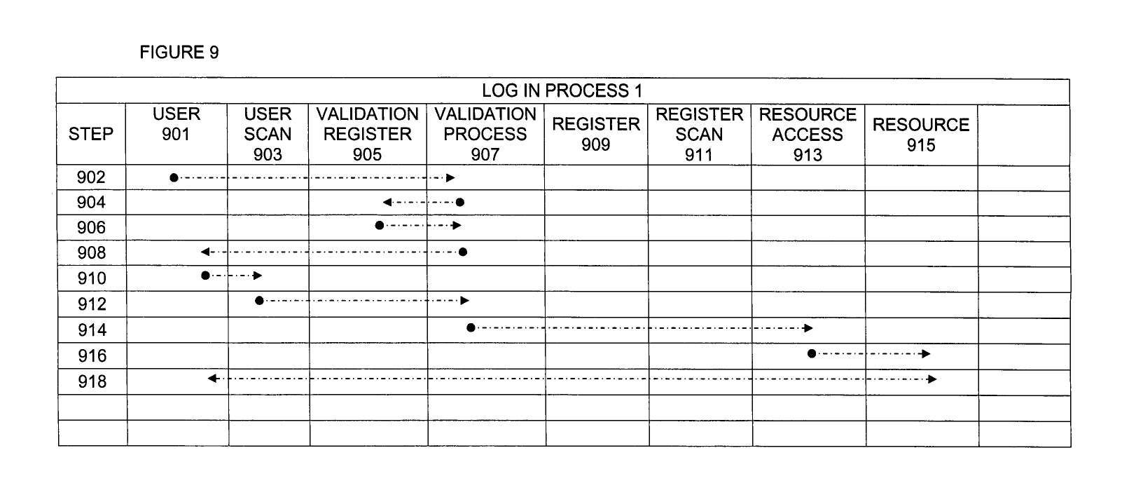

FIG. 9 is a process chart illustrating a log in process according to an embodiment of the invention. As step 902, the user connects to the access validation function 907 of the access controller 905. In this embodiment, the user's initial message includes user identification information such as user ID and password, which can have been set up during the registration process described with reference to FIG. 8, or updated by the user from time to time via the access controller 905. Other information, such as URL may also be included. The access validator 907 retrieves the user details including the stored fingerprint data from the access control's memory and, at 908, requests the user to scan a fingerprint. The user 902 scans the appropriate fingerprint using the user scanner 903 at step 910, and the fingerprint data is transmitted to the access validator 907 where it is cross-checked with the stored fingerprint data from the access control memory.

Upon validation, the access validator 907 notifies the resource access regulator 913 that a valid attempt has been made by the user having the user identification details included in the message. The resource access regulator 913 uses the user identification information to determine to which portion(s) of the resource the user has access, and to enable access to those portions at step 916. The user is then enabled to access the designated portions of the resource at step 918.

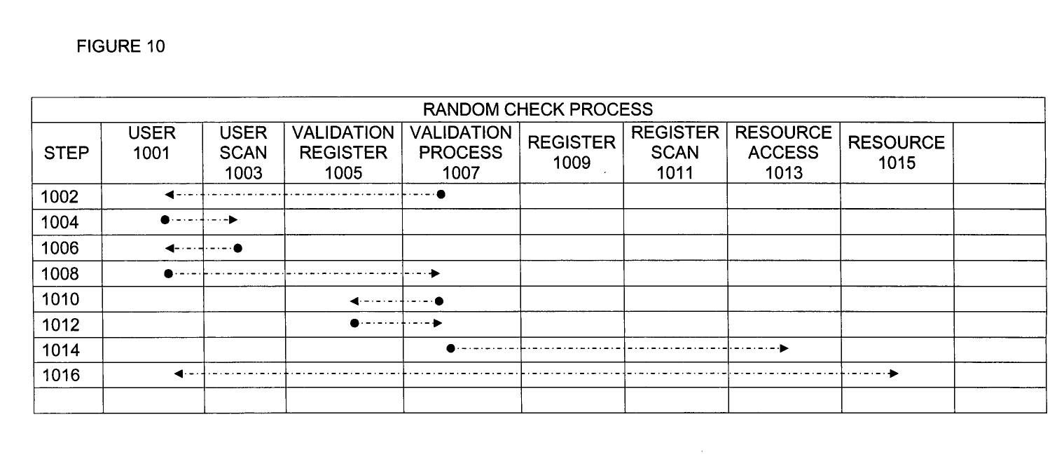

FIG. 10 is a process chart illustrating a random check process according to an embodiment t of the invention. At a randomly chosen time during an access session by a user, the registration validater 1007 sends a validation request to the user terminal 1001 at step 1002. In response, at step 1004, the user scans a finger print as required using the user fingerprint scanner 1003. This is relayed via the user terminal 1001 (step 1006) to the access validater 1007 (step 1008). Again, the validater 1007 checks the newly received fingerprint data with the fingerprint data stored in the access controller 1005 (1010, 1012). On receipt of a matching result, the access validater 1007 sends a validation message to the resource access manager 1013 to maintain the session at step 1014.

The system may permit more than one attempt to match the fingerprint data. In the event that the newly received fingerprint data does not match the fingerprint data in the access controller 1005 after the allowed number of attempts, a message is sent at step 1014 to terminate the session.

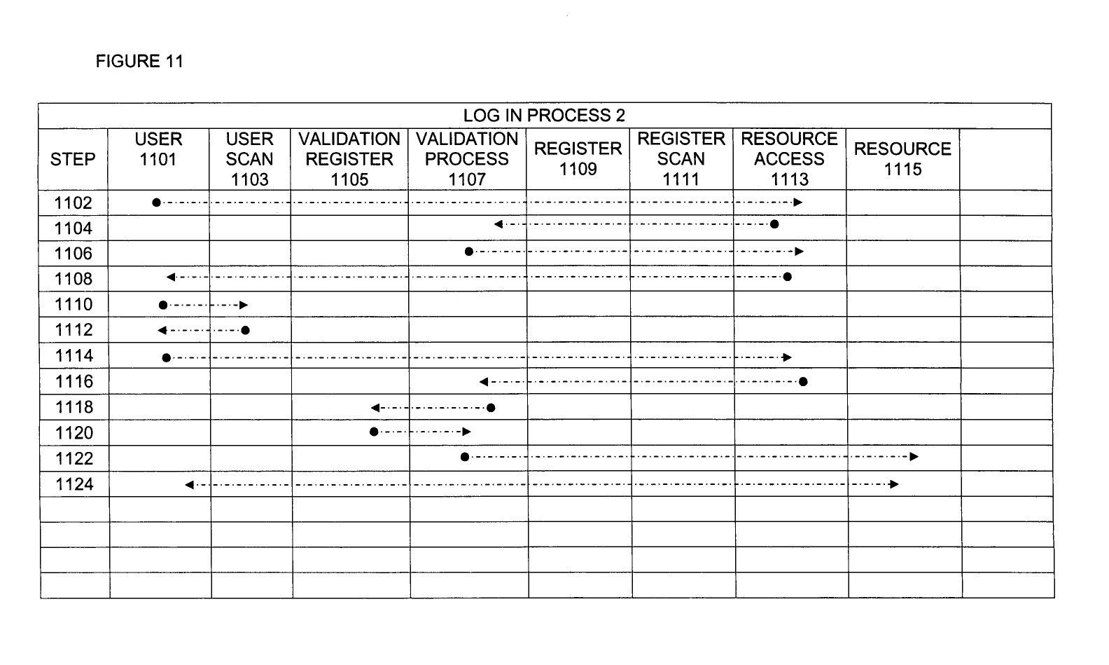

FIG. 11 is a process chart illustrating an alternative log in process according to an embodiment of the invention. In this embodiment, the user logs in via the resource server, and the resource server acts as a relay between the user and the access controller.

At step 1102, the user 1101 requests access via the resource access manager 1113. The request can include the user ID and password, and this is relayed by the resource access manager 1113 to the access validator 1107 at step 1104. The access validator transmits a request to the user 1101 via the resource access manager 1113, requiring the user to provide fingerprint data at steps 1106, 1108.

The user then scans the required fingerprint at 1110, and this is transmitted to the access validator 1107 via the user terminal 1101 and the resource access manager 1113 at steps 1112, 1114, 1116.

The access controller 1107 retrieves the user's registered fingerprint data from the access control memory 1105 at steps 1118, 1120 and verifies the newly received fingerprint data. Where the new fingerprint matches, the access validator notifies the resource access manager 1113, and the authorized access is granted to the user at 1124.

FIG. 2 is a functional schematic diagram illustrating typical functional blocks of a computer. The computer can include a microprocessor 202, RAM 204, ROM 206, hard disc 206, a screen driver 212, a touch screen interface 214, a user interface (keypad, mouse, etc), a biometric reader interface 224, and communications interface 226. The devices are shown interconnected by a single bus 220, but, in practice, other functional block architectures can be used.

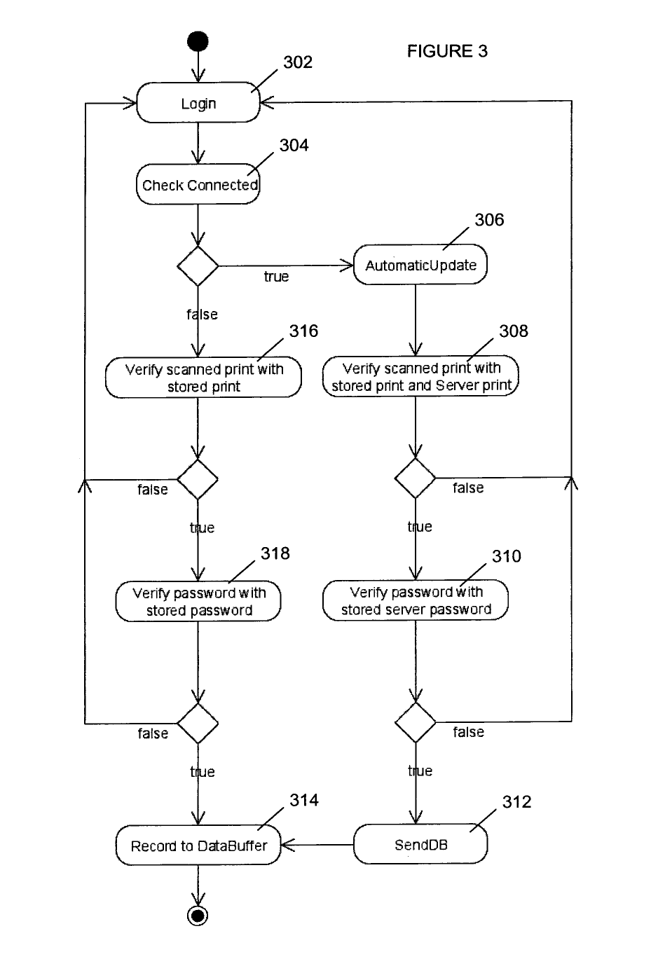

FIG. 3 illustrates a flow diagram of an access process according to an embodiment of the invention. The user logs in at 302, and a check is carried out at 304 to determine whether the user terminal is connected to the resource database.

If, as on a startup attempt to log in, the user is not connected to the resource terminal, a message is displayed on the user's screen requesting the user to enter the appropriate fingerprint, and this is checked at 318. If the verification is unsuccessful, the access attempt is rejected, and the user terminal returns to the login screen 302. If the fingerprint is verified, an additional optional password verification can be implemented at 318, and, if this fails, the user is again returned to the login at 302. If the password is correct, the user again is given access to the information which has been downloaded for the session at 314.

Where the user is connected, an update can be carried out on a random or pseudo-random basis at 306, so the user is required to re-enter the fingerprint at 308.

In the case where a random verification is carried out, the user will be logged in and connected to the resource terminal, so the connection check at 304 will proceed to the automatic update process 306. The user will be requested to re-enter the fingerprint for verification at 308. If the fingerprint does not match, the session is terminated and the process returns to the login 302. If the fingerprint is validated at 308, the optional password verification can be carried out at 310, and depending on the outcome, the user is enabled to continue the session at 312, or the process returns to the login 302.

FIG. 4 illustrates the functional blocks of a user terminal according to an embodiment of the invention. The user terminal 400 includes the user system software required to obtain verification from the authentication terminal and to access the resource database. This software can be used in conjunction with the server end software to log user access and track user progress.

The user terminal 400 also includes a communication functionality 404 adapted to enable the user terminal to communicate over one or more communication links to the verification terminal and the resource terminal.

The user terminal can also include a biometric reader interface adapted to enable the user terminal to communicate with the biometric reader, such as fingerprint reader 410. The biometric reader can also include interface functionality for example in the form of a USB communication functionality. Thus the reader 410 can be in the form of a USB stick with a built-in fingerprint or other biometric reader.

A second plug-in device can act as a dongle having the user identification, access and biometric data recorded therein. However, in one embodiment, the information can be incorporated in the same device as the biometric reader 410.

An encryption function 408 can also be incorporated into the user terminal 400 to enable transmissions from the user to the verification terminal and/or the resource terminal to be encrypted. A decryption function can also be included for downstream traffic.

FIG. 5 is a functional block diagram of a registration terminal 500. The registration terminal includes registration software 502 adapted to enable the registration terminal to implement the registration function. The user registration terminal can have one or more biometric sensors 510 adapted for producing user specific biometric information, and this information is sent to the registration system 502 via the biometric reader interface 506. For example, USB interface protocols can be used. The user details such as user identification information can be entered and matched with corresponding biometric data using this software 502. The registration terminal also records user access information concerning the data to which the user is authorized to have access. The communication interface 504 enables the transmission of the user specific biometric information and user identification information to the user register after encryption at 508. The registration terminal can also include a dongle writer 510 adapted to record the fingerprint information and user identification information and access details in encrypted form a USB stick or other plug in device to be used in enabling the user terminal to access the resource information.

FIG. 6 is functional diagram of a validation terminal 600. the validation system 602 enables the validation terminal to implement the validation functions according to an embodiment of the invention. The validation terminal includes a user register which stores the user registration information including ID and biometric information received from the registration terminals. The validation software and user register enable the validation terminal to perform user validation when a user makes an attempt to access the resource database. The validation terminal includes communication functionality to enable the validation terminal to communicate with the resource terminal, the user terminal and the registration terminal as required, again using encryption and decryption 608 as required.

Thus, when a user has registered at a registration terminal, the registration terminal communicates the user identification and biometric data to the validation terminal. the validation terminal can also have the user access rights in the user register, either from the registration terminal or from the resource database. thus, when a user attempts to log in to the resource database, the login attempt is directed to the validation terminal, and the validation system caries out a validation process such as that described with reference to FIG. 3.

FIG. 7 illustrates functional elements of the resource terminal. This terminal can include a network of computers, servers, etc., connected by a network such as LAN, WAN, etc. A communication interface 704 enables communication between the resource terminal and other elements of the system. The resource system software 718 enables the interactions between the resource terminal and the user terminal, the validation terminal, and, in some embodiments, the registration terminal.

The resource system 700 can include access control function 706, which, in response to the validation system, grants or refuses access to a user terminal. The resource terminal includes resource information 720 which can include one or more resources, such as information, software, course examinations, progress logs, supervisor reports, etc., and the user may have limited access to only some of those resources, such as a semester of a particular subject. This may also be made to depend on progress through the course, so that units of the course must be completed before progress to the next unit is permitted.

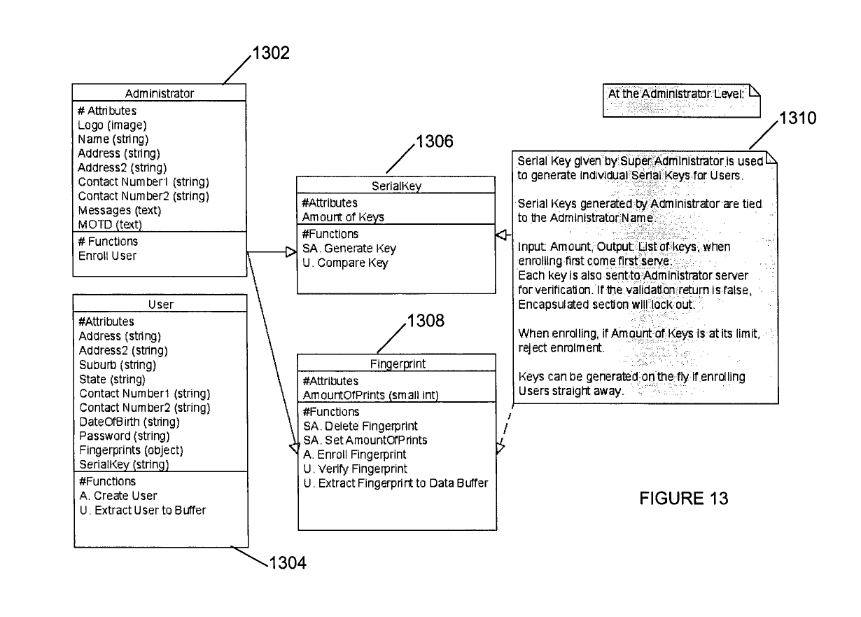

FIG. 8 is a flow chart illustrating the registration process according to an embodiment of the invention, while FIG. 13 shows details of the enrolment process. The elements of the flow process illustrated in FIG. 8 include: user 801, user scanner 803, register 805, register scan 807, encoder 809, USB writer 811. In this and the following flow charts, the user and the user terminal are treated as a single entity, although the person skilled in the art will understand that some functions are carried out by the user and some carried out by the user terminal.

The user may have already received pre-registration information from the institution providing the on-line course, such as course codes, enrolment payment, etc. In step 802, when a user wishes to register for a course or other access to information controlled by the system, the user attends a registration centre which is equipped with a registration terminal including register 805 and register scanner 807, and provides the required information such as personal details, institution details, course details, password, contact details, etc (see 1304 in FIG. 13). At step 804, the user scans in the required biometric information via the register scanner 807, and this is also recorded in the register 805 in association with the user details from step 802. The registration details and fingerprint data are encoded by encoder 809 at step 808 and written to the USB stick via USB writer 811 at step 810. The encrypted information can also be sent to the validation register 813 at step 812.

FIG. 9 is a flow chart illustrating a log in process according to an embodiment of the invention. The elements of the process include User 901, user scanner 903, validation register 905, validation process 907, resource access 913, and resource 915.

A user 901 attempts to log into the resource 915, and is diverted to the validation process 907 at step 902. User identification information in the validation register 905 is sought at step 904, and, if the user is registered, the user details are retrieved at step 906 for use in the validation process. At step 908, the validation process requests the user 901 to provide the fingerprint information. The user scans in the required information at step 910 using the user scanner 903, and this information is returned via the user terminal (not shown) to the validation process 907 at step 912. If the fingerprint is recognized, the validation process arranges for access to be provided to the user 901 by notifying the resource terminal access control 913 at step 914. At step 916, resource access control 913 then enables the setting up of a communication link between the user 901 and the resource 915 at step 918.

FIG. 10 illustrates a random validation process during a session. At step 1002, the validation process 1007 sends a request to the user 1001 terminal to re-enter fingerprint information. The user scans in the required information at step 1004 using user scanner 1003 and this information is relayed in steps 1006, 1008 to the validation process 1007. At steps 1010, 1012, the users fingerprint details are retrieved from the validation register 1005 by the registration process 1007 and compared with the information received from the user 1001. At steps 1014, 1016, if the comparison was correct, the validation process authorizes the continuation of the access between the user 1001 and the resource 1015.

FIG. 11 illustrates an alternative log in process, in which communication between the user and the validation register is carried out via the resource terminal. The user attempts to log in to the resource 1115 at step 1102. The log in attempt is intercepted by the resource access control 1113 and relayed to the validation process 1107. At steps 1106, 1108, the validation process 1107 sends a request via the resource access control 1113 for the user to provide the required fingerprint information. At steps 1110 to 1116, the user scans in the fingerprint information and returns it to the validation process via the resource access control.

The validation process retrieves the user's fingerprint information from the validation register (steps 1118, 1120), and carries out the validation check at steps 1118, 1120. A valid check results in the validation process authorizing the continuation of the session at steps 1122, 1124.

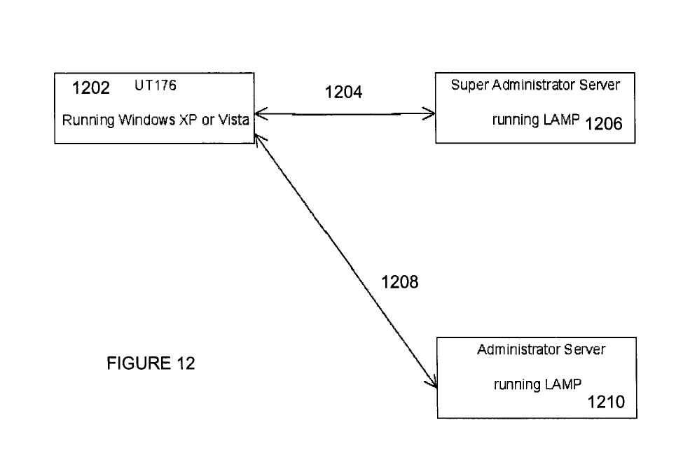

FIG. 12 is a block diagram illustrating the administration levels of the system suitable for incorporation in a USB device. 1202 is the user terminal which can use, for example Windows XP or Vista, 1204 is the administrator server which can run LAMP (Linux, Apache, My SQL, PHP), and the superadministrator 1206, also running LAMP.

FIG. 13 illustrates interactions during an enrolment showing database relationships in UML. The administrator's details such as name, address contact details are shown at 1302, together with messages and message of the day.

Similarly, details of the user are incorporated at 1304.

The administration enrolment function is used to generate a serial key for each user from a serial key allocated by the superadministrator at 1306. The serial keys generated by the administrator are tied to the administrator's name. The user data is extracted to a buffer.

At 1308, the user's fingerprint is scanned, enrolled, and verified, and the fingerprint data is extracted to the data buffer.

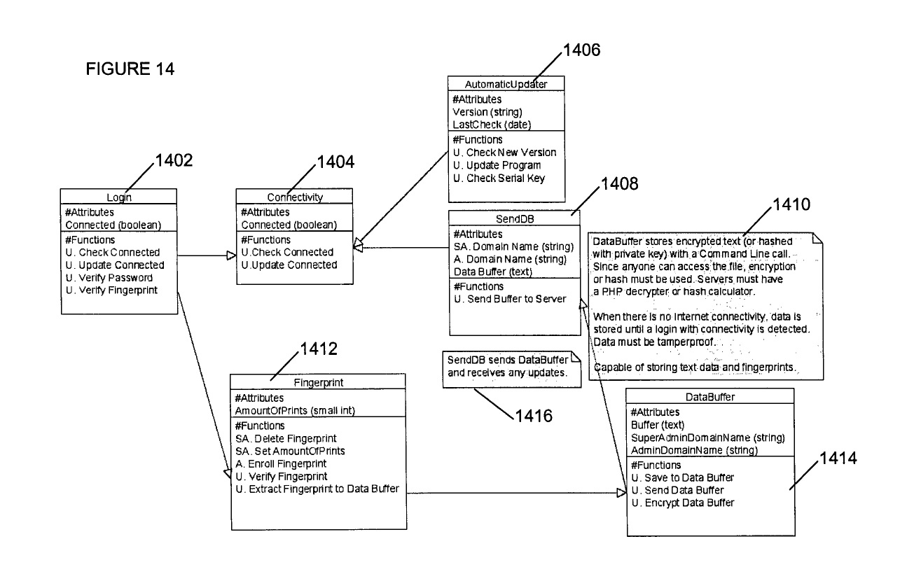

FIG. 14 illustrates the login process. During login 1402, the connection is checked at 1404, and the user password and fingerprint are verified at 1412.

At 1406 a check for new versions of the data is carried out and updated as required.

At 1408, the database is sent to the data buffer using the domain name. The data buffer stores encrypted text.

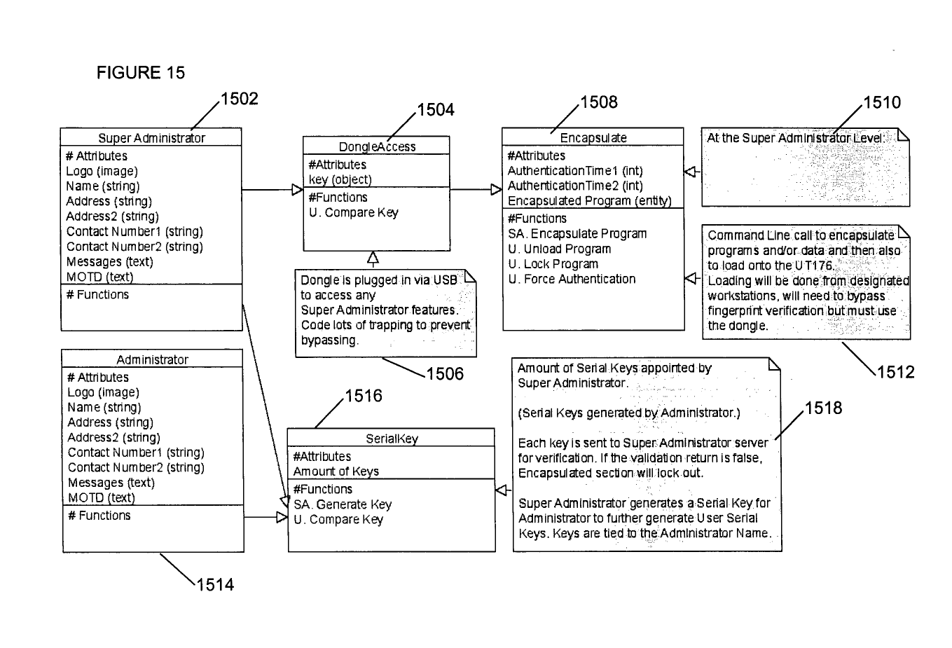

FIG. 15 illustrates login interactions showing the user level and operational options at each level of administration. The device 1504 is plugged in and two authentication attempts are provided for at 1508, and programs and data are encapsulated and loaded into the device at 1512.

The superadministrator 1502 and administrator 1514 verify a serial key to access encapsulated data at 1516.

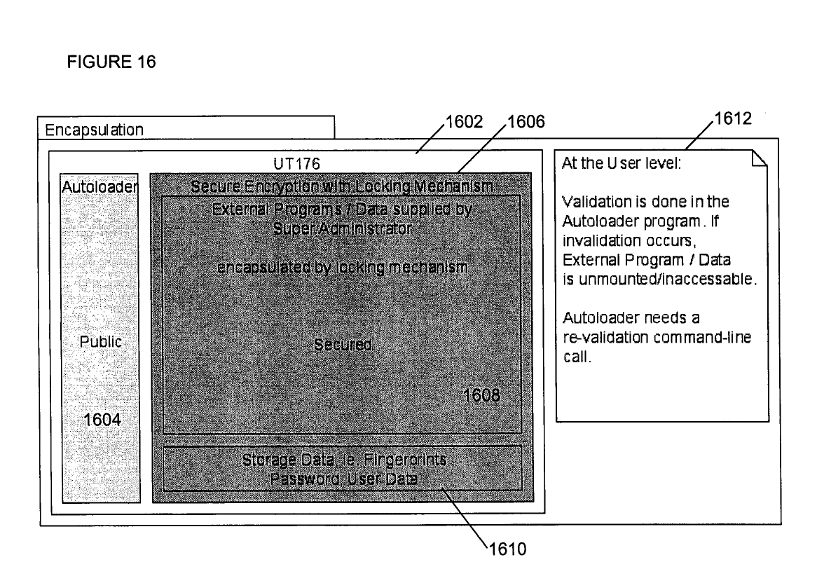

FIG. 16 illustrates message encapsulation and biometric information encryption, and the layout and relationship between the components being encapsulated. The autoloader program 1604 implements the encryption and encapsulation of user information (fingerprint, password, identification information) 1610, and external programs and data supplied by the superadministrator which are encapsulated by a locking mechanism at 1606. The autoloader also implements the validation and re-validation process at the user level at 1612.

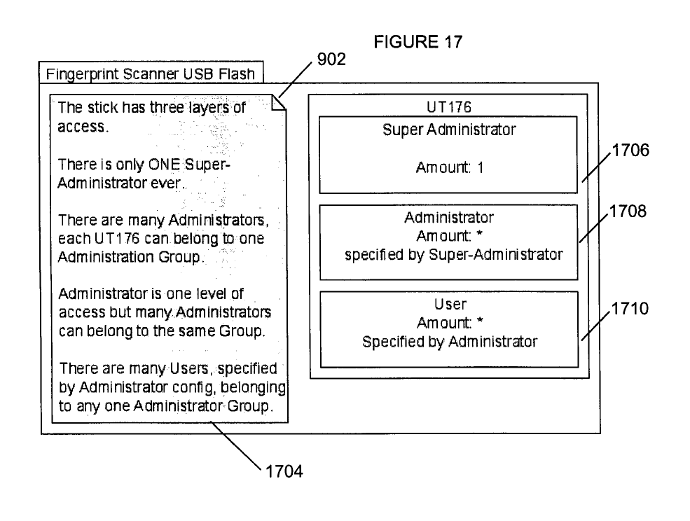

FIG. 17 illustrates fingerprint reader administration having a single super administrator 1706, one or more administrators 1708 as specified by the superadministrator, each administrator belonging to a group, and one or more users at each level as specified by the administrator of the corresponding group and stored on the USB device.

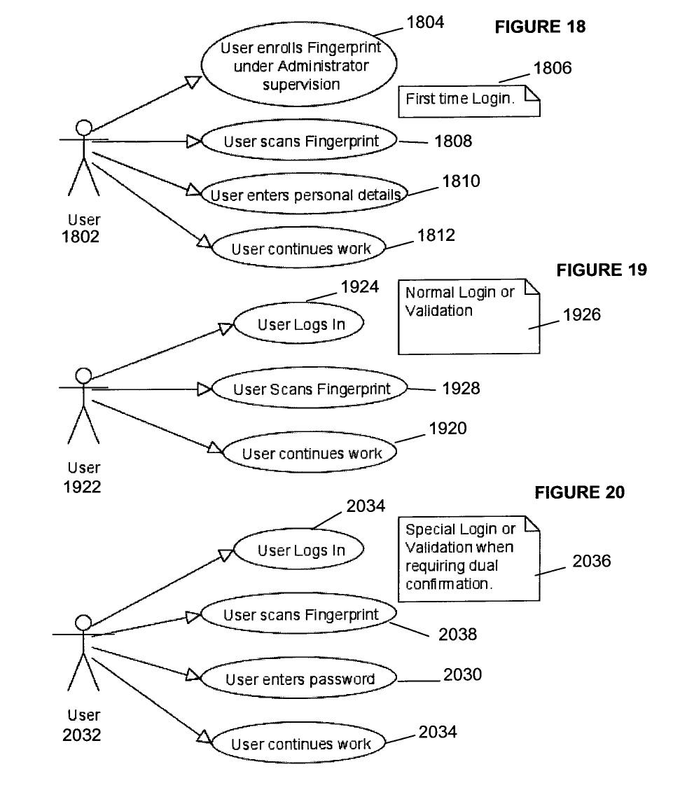

FIGS. 18 to 20 illustrates use case diagrams showing initial login, normal login, and dual confirmation from the user viewpoint.

In FIG. 18, a first time user 1802 enrols a fingerprint at 1804 by scanning finger at 1808 and enters personal details at 1810, and is enabled to work on the authorized resources at 1812.

In FIG. 19, user 1922 logs in at 1924 by scanning a fingerprint at 1926, and is given access to the resource at 1920.

FIG. 20 illustrates a dual login process in which user 2032 is required to scan a fingerprint at 2038 as well as to enter a password at 2030 before being granted access at 2034.

In an alternative embodiment, it is possible, once a user has been registered, to load the verification function and the course information on to the USB key together with the biometric recognition functionality to provide stand-alone access to the course. It is not necessary to load the entire verification database on to the device if it is intended that only one user will have access to the resource information. Only the validation information for the intended user need be loaded onto the device.

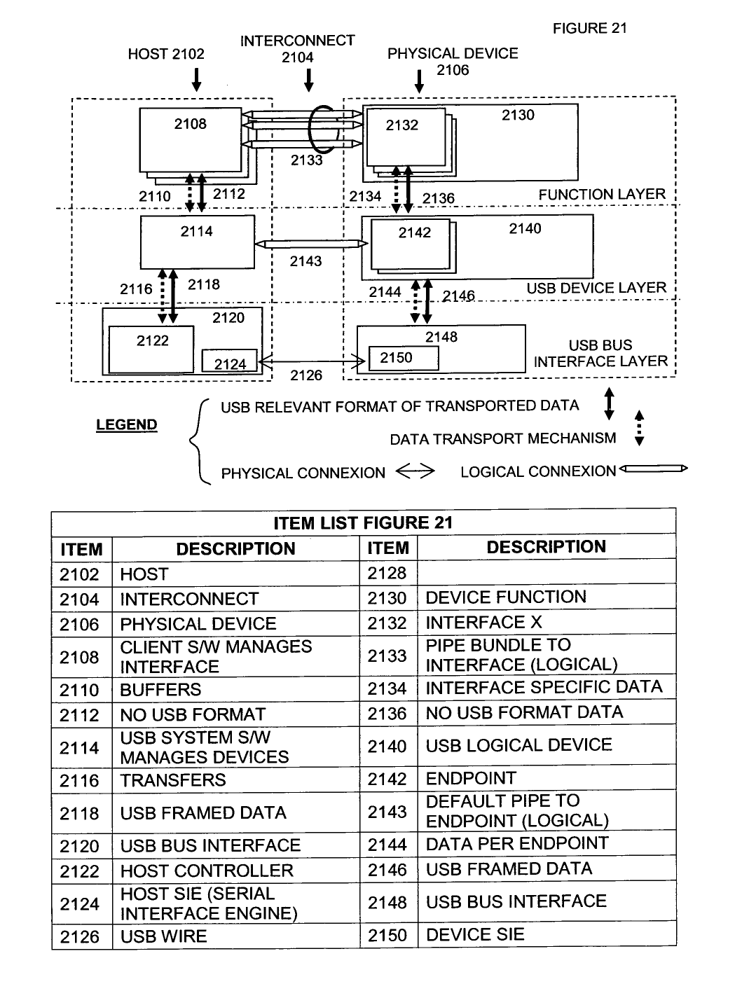

FIG. 21 illustrates a USB device and host.

2102 is the host computer. 2104 shows the logical and physical interconnections. 2106 represents the device carrying the identification, validation and resource functions and information. 2108 is the host's client software to manage the interface. 2114 is the USB system software which manages the devices. 2120 is the host's USB interface having a controller 2122 and a serial interface engine (SIE).

At the level illustrated, the device 2106 has three layers—the functional layer, the device layer, and the USB interface layer.

The host 2102 and device 2106 are connected by the USB cable 2126.

In the device 2106, the device functionality is shown at 2130. Logical connections are provided to the client software 2108 via the logical connections 2133 and interfaces 2132. The USB logical device is shown at 2140 in the USB device layer as including endpoints 2142. This is logically connected via default pipe 2143 to the host's USB system software which manages the device. Communication between the device 2106 and the host 2102 is via the physical USB link 2126. The device's USB interface 2148 includes a SIE 2150 for this purpose.

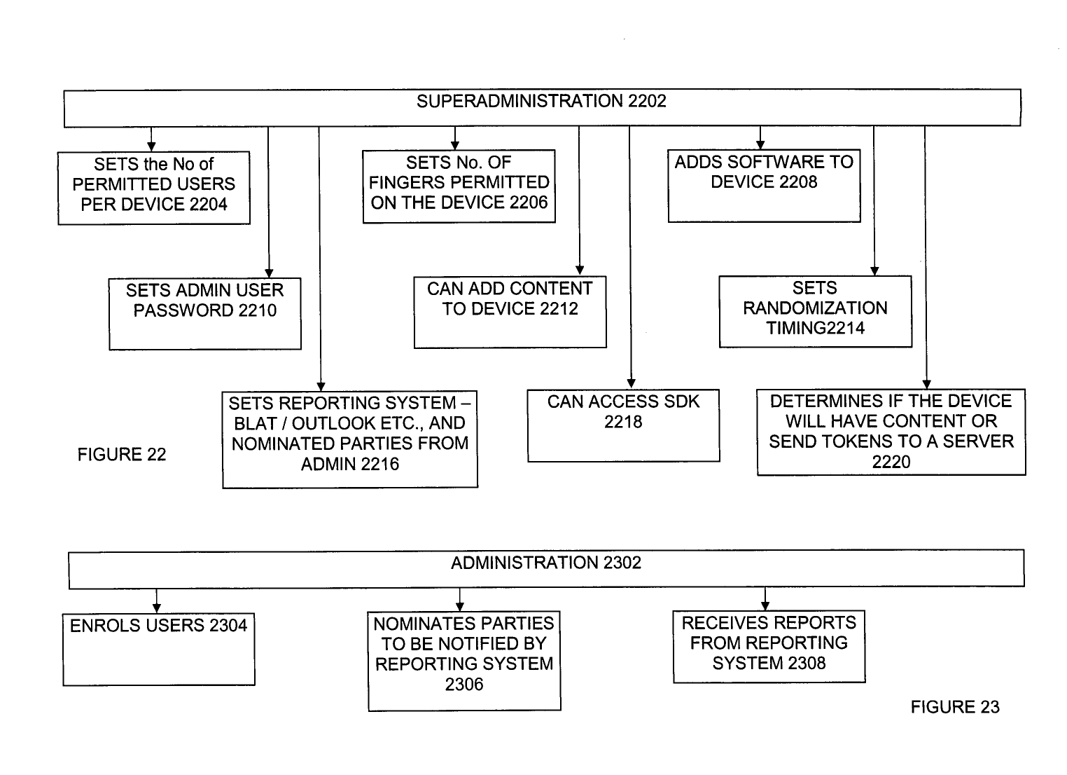

FIGS. 22, 23 & 24 are block diagrams illustrating a multi-level administration arrangement of a device such as 2106 according to an embodiment of the invention. The validation and access control functionality and resource storage are incorporated into the functional layer of the device.

As shown in FIG. 22, the superadministration level 2202 controls the following features:

the number of users permitted to be registered in relation to the device 2204;
the number of finger prints permitted on the device 2206;
loading software to the device 2208;
setting of administration passwords 2210;
loading content to the device 2212;
setting the reporting system and addressees 2216;
software development kit (SDK) access 2218;
device content and server communication.

As shown at 2204, there can be more than one user registered for the device. Each user will have a profile recorded in the device and associated with the biometric and optional password identification, together with the resource access and user progress log.

Each user can register a permitted number of fingerprints as shown at 2206.

The superadministrator also controls the registering of passwords at 2210.

The superadministrator also controls the loading of content and software to the device at 2212, and 2208.

The randomized timing of the revalidation checks is set by the superadministrator at 2214.

The reporting system is controlled by the superadministrator at 2216 and can use email such as Outlook or other suitable system.

The superadministrator also determines whether the device will use locally stores resource content or provide tokens for access to a remote server at 2220.

FIG. 23 shows the administrator level 2302 of the device. The administrator manages the enrolment of users 2304, the nomination of the addressees of the reporting system 2306, and receiving of reports from the reporting system 2308.

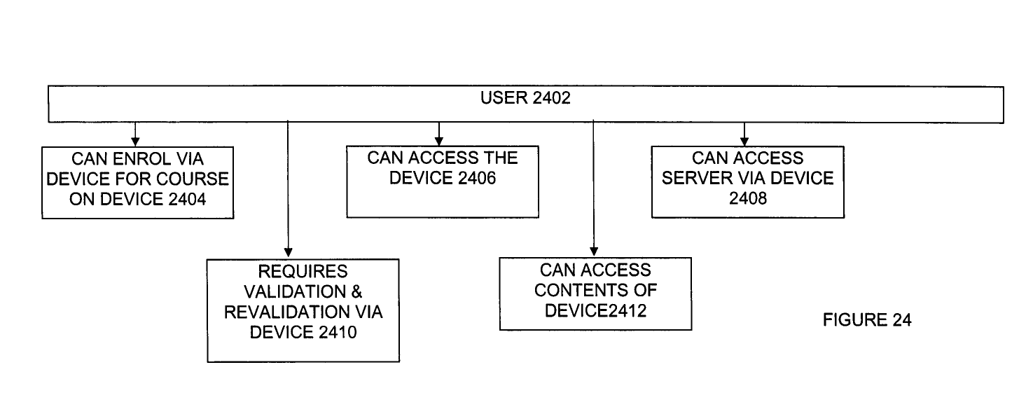

The user level administration 2402 is shown in FIG. 24. The user is enabled to enrol for a course by using the fingerprint scanner built into the device at 2404. The user administration also provides access to the device 2406, the device content 2412, and to a server 2408.

Login and revalidation are also implemented at this level 2410.

Where there are two or more users, each user access is quarantined from other users, so that, while common resource material and functions can be accessed by the appropriate authorized users, user specific information such as user files, progress reports etc., are accessible only by the designated user.

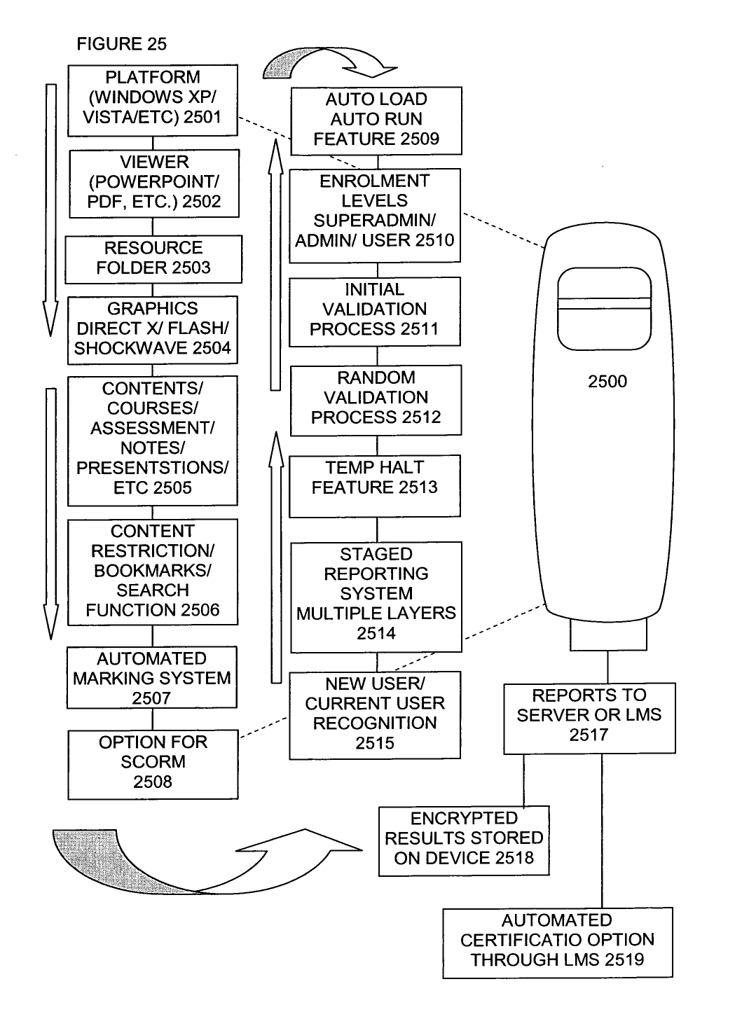

FIG. 25 illustrates the stand alone USB apparatus which includes the features set out below.

2500 stand alone apparatus USB FPV device.

2501 Windows XP Windows Vista Platforms—this permits the stand alone device to operate under both environments.

2502 Powerpont viewer PDF viewer Other Viewer—these viewers maybe required by the end use if not installed on the user terminal.

2503 Resource Folder contains resources required by the stand alone USB apparatus.

2504 Direct X Flash Shockwave functions are installed by the stand alone USB apparatus if the user terminal does not have these required features already installed.

2505 Contents/courses/assessment/notes/presentations etc—the contents are formed into an .exe file which the stand alone USB apparatus can use as required

2506 Content restriction Bookmarks Search function—the content of the stand alone USB apparatus can be restricted dependant on user skill level/bookmarks can be stored to enable the user to return to the exact point from a previous session/search function permits the user to search for keywords etc within the stand alone .exe file.

2507 Automated marking system this step permits the assessments or other data being used on the stand alone FPV USB apparatus to be scored against predetermined results within the stand alone .exe file—these results once calculated are then reported to the nominated parties as set by admin.

2508 Option for SCORM compliancy—this option can be applied to the contents packages as required by various departments educational facilities etc.

2509 Auto Load Auto Run Feature—this feature permits the stand alone USB apparatus to auto run without any further input from the end user.

2510 Various Enrolment Levels—super admin/admin/user this section permits different access levels to the stand alone USB apparatus and also permits the uploading and downloading of information to the stand alone USB device.

2511 Initial Validation Process—this is the first validation as set by the admin level and grants or denies access to the stand alone USB device—the result of this initial validation and the subsequent sign in information is reported to the nominated parties as set out by the admin user see FIG. 8.

2512 Random Validation process see FIG. 10 & FIG. 11.

2513 Temporary halt feature—this features halts the current program being delivered by the stand alone USB apparatus and checks the re-validation process is true—if true then releases the program back to its present state—if false the program halts and sends a report to the parties nominated in the admin setup.

2514 Staged Reporting System—Multiple Layers this step can report to multiple levels or to an LMS as determined by admin.

2515 New User Current User Recognition—this step determines if the user is a new user or a current user—new users are sent to the enrolment section of the stand alone .exe—current users are returned to the main menu of the last current session.

2516 Fully upgradeable—the stand alone USB apparatus is fully upgradeable to allow for future changes in operating systems etc.

2517 Reports to a server or LMS—the stand alone USB apparatus may communicate through a network to a Learning Management System if required by educational institutions and facilities.

2518 Encrypted results stored on USB device—the results of scored assessments are stored on the stand alone USB device prior to being reported via a network—if the user is not connected to a network—the stand alone USB apparatus stores the results until the next available connection—at which time the results are sent to the parties nominated by admin—an encrypted set of results may also be stored on the USB apparatus or on the users' terminal.

2519 Automated certification option through LMS—this feature permits a certificate to be printed via the LMS directly to the end user on successful completion of the nominated session.

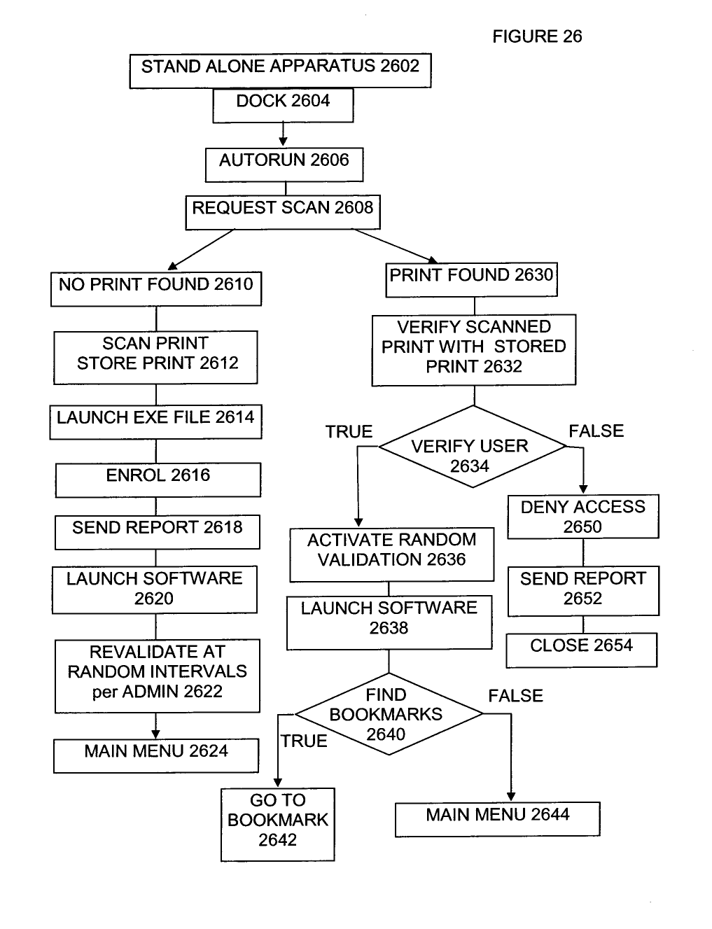

FIG. 26 is a flow diagram illustrating the operation od the device in enrolling or granting access to a user.

The device is docked with the user's PC 2602 at 2604. This automatically triggers the authentication function in the device at 2606. A request is displayed on the screen for the user to scan a fingerprint at 2608. The program then decides whether to initiate an enrolment process or to initiate a user verification process.

If no fingerprint is found, the scanned print is stored at 2612 and the enrolment program is initiated at 2614, 2616 which may also require additional input from the user, such as name, student number, course code, etc. The device encrypts and transmits the user data to the server at 2618 using, for example, an email message. The encrypted user data including the fingerprint information and other user information can also be stored on the device. Once the user has been enrolled, the resource access can be activated, and random verification can be carried out.

Where a stored print is found 2630, the user's scanned print is verified against the stored print 2632. In the event of a successful validation 2634, the random validation process is initiated at 2636 and he resource software is launched at 2638. This can for example, look for the bookmark 2640 indicating the last stage reached by the user, and, if a bookmark is found, the program finds the appropriate point in the resource data. If no bookmark is found, the program is directed to the main menu of the resource.

Where the user is not verified at 2634, access is denied at 2650, a report is sent to the managing server at 3652, and the system closes at 2654. A permitted number of retries can be allowed before the system closes.

Fingerprint verification is one of the most reliable personal identification methods.

Typically, a complete fingerprint verification procedure takes on average about eight seconds, and the verification accuracy is found to be more than acceptable throughout learning and corporate environments.

In one embodiment, the user scanner is programmed to incorporate time of day information with the fingerprint data. Preferably, this information can be incorporated as a “watermark” in the fingerprint data.

While the term “terminal” has been used to refer to the various computer based devices, it is to be understood that, in this specification, this term can also refer to a single laptop or a group of computers, servers, etc., connected via a network such as LAN, WAN, etc.

In this specification, depending on the context: “resource” can include data and/or executable code; “function” can include executable code; “terminal” can include a PC, a laptop computer, a handheld computer, a server, and the like; and “store” as a noun includes all forms of digital storage including electronic, magnetic, and optical.

In this specification, reference to a document, disclosure, or other publication or use is not an admission that the document, disclosure, publication or use forms part of the common general knowledge of the skilled worker in the field of this invention at the priority date of this specification, unless otherwise stated.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A controlled access storage device including a resource store storing two or more resources, the resource store having two or more levels of administration, wherein at least a first administration level is adapted to provide exclusive access to at least a first resource.

2. A storage device as claimed in claim 1, having three administration levels.

3. A device as claimed in claim 1, including a super administration level, an administration level, and a user level, wherein the super administration level has exclusive access to/control of one or more of:
resource content;
course content;
resource software;
reporting function;
reporting software;
software development kit;
administration software;
set the number of authorized users;
number of user identification parameters;
revalidation timing settings;
setting the administration level password to permit the Admin level user to enrol a user.

4. A storage device as claimed in claim 1, including an administration level having access to/control of one or more of:
user enrolment/s;
reporting mailing list;
report reception.

5. A storage device as claimed in claim 1, including a user level having access to one or more of:
user enrolment;
user validation process;
user revalidation process;
device;
device content;
access to remote server.

6. A storage device as claimed in claim 5, including encryption software adapted to encrypt the biometric information.

7. A storage device as claimed in claim 1, including a biometric characteristic reader and a biometric identification program adapted to record biometric information of a user in the storage device, the biometric information being available to be used to validate user identity.

8. A storage device as claimed in claim 1, wherein the storage device is a USB device.

9. A storage device as claimed in claim 8, wherein the resource store includes a FLASH memory.

10. A method of verifying the presence of an authorized user during an attempt to access a resource stored in a first store, the method including the steps of:
recording and storing at least one biometric characteristic of an authorized person in an authorization store together with associated used identity information;
receiving a log-in request from a user;
requesting the user to provide specified biometric information;
receiving specified biometric information from the user;
comparing the biometric information with the biometric characteristic;
if the biometric information matches the biometric characteristic, granting access to the resource store.

11. A method as claimed in claim 10, wherein, if the biometric information does not match the biometric characteristic, access to the resource store is inhibited.

12. A method as claimed in claim 10, wherein the log-in request includes user identification information.

13. A method as claimed in claim 10, wherein if the log-in request does not contain user identification information, user identification information is requested from the user on receipt of the log-in request.

14. A method as claimed in claim 10, wherein, when a user has been granted access, one or more subsequent requests for user biometric information are made.

15. (canceled)

16. An access controller adapted to mediate access between one or more user terminals and a resource terminal, the access controller including:
a memory adapted to store user registration information including user identification information and associated user specific registration biometric information;
biometric information analysis means adapted to compare registered user specific registration biometric information with request biometric information associated with an access request from a user terminal;
the controller being adapted to authorize/enable or deny/inhibit the user terminal to access at least a designated part of the resource on the basis of the comparison.

17. An access controller as claimed in claim 16, wherein the user registration information includes associated user access information.

18. An access controller as claimed in claim 16, wherein the access controller is adapted to receive user specific registration biometric information from registration means.

19. An access controller as claimed in claim 18, wherein the registration means includes a biometric scanner.

20. An access controller as claimed in claim 16, wherein the registration means includes digitizing means to convert the scanned biometric characteristic to digital format.

21-38. (canceled)

39. A user authorization system utilizing fingerprint verification means and random re-validation to prevent unauthorized access of data stored in the apparatus.
